(19) United States
(12) Patent Application Publication
(10) Pub. No.: US 2021/0340698 A1
(43) Pub. Date: Nov. 4, 2021

(54) MOP CLEANING CLOTH AND METHOD FOR MANUFACTURING SAME

(71) Applicant: HAINING WELLINGTON NEW MATERIAL CO., LTD., HAINING (CN)

(72) Inventor: WEICHU WU, HAINING (CN)

(73) Assignee: HAINING WELLINGTON NEW MATERIAL CO., LTD.

(21) Appl. No.: 17/374,457

(22) Filed: Jul. 13, 2021

Related U.S. Application Data
(62) Division of application No. 16/146,337, filed on Sep. 28, 2018.

(30) Foreign Application Priority Data
Sep. 10, 2018 (CN) 2018110501546

(51) Int. Cl. D04B 21/20; A47L 13/16; B32B 33/00; D04B 23/16; D04B 27/02; D04B 27/24; B32B 5/26; B32B 5/06

(52) U.S. Cl. CPC D04B 21/20; A47L 13/16; B32B 33/00; D04B 23/16; B32B 9/047; D04B 27/24; B32B 5/26; B32B 5/06; D04B 27/02

(57) ABSTRACT

The present invention provides a mop cleaning cloth and a method for manufacturing the same. The mop cleaning cloth comprises, sequentially from bottom to top, a base cloth layer, a water-absorption layer and a dirt removal layer. The dirt removal layer is formed by high terry fabrics and low terry fabrics. The ratio of the terry height of the high terry fabrics to the terry height of the low terry fabrics is 1.1-5:1. The high terry fabrics have a terry height of 2-20 mm and low terry fabrics have a terry height of 1-10 mm. The water-absorption layer is formed by a water-absorption fabric made from water-absorption fibers. The base cloth layer is formed by a terry fabric. The manufacturing method is simple, and the mop cleaning cloth is easy to manufacture and has the advantages of being small in resistance, high in water absorptivity and dirt collection and removal capacity, and the like.

This is a Divisional application of U.S. application Ser. No. 16/146,337, filed Sep. 28, 2018, which claims the priority benefit of Chinese Application No. 2018110501546, filed Sep. 10, 2018, all of which are hereby incorporated by reference.

### BACKGROUND OF THE INVENTION

### Technical Field

The present invention relates to a household article, in particular to a mop cleaning cloth and a method for manufacturing the same.

### Description of Related Art

Mops have always been used as cleaning tools. In early days, the cleaning cloths of mops were mostly pure cotton cloth, which had the advantage of high water absorptivity.

However, with the popularization of wood floors in common family homes at present, traditional twist mops with pure cotton cleaning cloth encountered various problems in use despite of their high water absorptivity. The main problems are that these twist mops are prone to contamination, difficult to clean, prone to erosion, fast in loss and difficult to store. Besides, pure cotton cloth has the problems of high cost etc.

The progress of science and technology has led to the development of flat mops. The choices for materials applicable to the mop cleaning cloths of the flat mops are becoming increasingly wider and wider. Cotton cloth strips were used in the early stage, afterwards, non-woven fabrics and ultrafine fibers were developed, and nowadays, the mop cleaning cloths of most flat mops are made from 100% polyester fibers. However, due to unreasonable material matching, such mop cleaning cloths may generate large resistance in use and have the water absorptivity inferior to that of pure cotton cloth, and consequentially, the cleaning effect is greatly reduced in the using process. In view of this, the materials and manufacturing methods of original mop cleaning cloths urgently need to be improved to adapt to market requirements.

### BRIEF SUMMARY OF THE INVENTION

To overcome the defects of the prior art, the present invention provides a mop cleaning cloth which is high water absorptivity, small in resistance and high in cleaning capacity and a method for manufacturing the mop cleaning cloth.

A mop cleaning cloth comprises, sequentially from bottom to top, a base cloth layer, a water-absorption layer and a dirt removal layer. The dirt removal layer is formed by high terry fabrics and low terry fabrics, wherein the ratio of a terry height of the high terry fabrics to a terry height of the low terry fabrics is 1.1-5:1. The high terry fabrics have a terry height of 2-20 mm. The low terry fabrics have a terry height of 1-10 mm. The water-absorption layer is formed by a water-absorption fabric made from water-absorption fibers. The base cloth layer is formed by a terry fabric.

The high terry fabrics of the dirt removal layer in the present invention have the dirt collection and adsorption capacity, and the low terry fabrics of the dirt removal layer can rub the floor to wipe off dirt on the floor. The water-absorption layer is used for absorbing sewage on the floor. The base cloth layer is used for fixing the dirt removal layer and the water-absorption layer and can conveniently bond with a mop head.

Preferably, the water-absorption fabric is a non-woven fabric, which is made from any one or two water-absorption fibers selected from cotton fibers, hemp fibers, hydrophilic polyester fibers and polyamide fibers. The hemp fibers have good water absorptivity as well as good antibacterial performance.

Preferably, the non-woven fabric of the water-absorption layer is made from high-melting point fibers and low-melting point fibers blended with the high-melting point fibers through a needle punching method, and after the blended fibers are reinforced into the fabric through carding, lapping and needle punching, the water-absorption layer is heated to melt the low-melting point fibers and to bond the high-melting point fibers together, and the overall hardness of the water-absorption layer is improved after cooling and shaping.

Preferably, the high-melting point fibers have a melting point over 200° C., and the low-melting point fibers have a melting point below 200° C. In the water-absorption layer. The high-melting point fibers have a mass fraction of 70-90%, and the low-melting point fibers have a mass fraction of 10-30%.

Preferably, the high-melting point fibers are polyester fibers or polyamide fibers, and the low-melting point fibers are PP/PET composite fibers, polyethylene fibers or polypropylene fibers.

Preferably, the water-absorption layer and the dirt removal layer are fixed on the base cloth layer through stitch-knitting by a warp knitting machine.

Preferably, the high terry fabrics and the low terry fabrics are made from ultrafine fibers having a denier of 150-600D/200-1000F. The high terry fabrics have a terry height of 3-10 mm, and the low terry fabrics have a terry height of 1-5 mm. A recommended denier of the ultrafine fibers can be 150D/288F, 300D/500F or the like. A recommended terry height of the high terry fabrics is 10 mm, and a recommended terry height of the low terry fabrics is 5 mm. The ultrafine fibers have good adsorbability and can better remove dirt such as hair, stains, dust and paper scraps.

The mop cleaning cloth is generally used in cooperation with a mop head provided with a hook face. When the mop cleaning cloth is used for mopping a floor, the base layer of the mop cleaning cloth is bonded and fixed on the mop head through a hook-terry structure. After the floor is mopped, the base cloth layer of the mop cleaning cloth is separated from the mop head, and the mop cleaning cloth can be repeatedly used after being cleaned or can be directly discarded.

The present invention further provides a method for manufacturing the mop cleaning cloth. The method for manufacturing the mop cleaning cloth comprises the following steps:

(1) manufacturing the base cloth layer: making a terry fabric of the base cloth layer;

(2) manufacturing the water-absorption layer: making a water-absorption fabric from water-absorption fibers;

(3) fixing the water-absorption fabric on the base cloth layer by stitching yarn through stitch-knitting, and meanwhile, stitching and knitting ultrafine fibers on the base cloth layer, so that the dirt removal layer formed by the high terry fabrics and the low terry fabrics is obtained, and accordingly, the mop cleaning cloth is obtained.

Preferably, in step (2), the water-absorption fabric of the water-absorption layer is a non-woven fabric made from high-melting point fibers and low-melting point fibers blended with the high-melting point fibers through a needle punching method, and the blended fibers are reinforced into the fabric through carding, lapping and needle punching. The method for manufacturing the mop cleaning cloth further comprises step (4): heating the water-absorption layer to melt the low-melting point fibers in the water-absorption layer and to bond the high-melting point fibers together, and obtaining the mop cleaning cloth after cooling and shaping. What should be noted is that in step (4), heating is conducted to melt the low-melting point fibers and to bond the high-melting point fibers together so as to improve the overall hardness of the water-absorption layer, but the high-melting point fibers and fibers in the dirt removal layer and in the base cloth layer should not be molten.

Preferably, in step (3), a warp knitting machine is used for stitch-knitting and is provided with two rows of guide bars, wherein the first row of guide bars are used for stitching and knitting the ultrafine fibers on the base cloth layer to obtain the dirt removal layer formed by the high terry fabrics and the low terry fabrics. The second row of guide bars are used for fixing the non-woven fabric of the water-absorption layer on the base cloth layer by stitching yarn; and the non-woven fabric is fixed on the base cloth layer by 75-100D stitching yarn through stitch-knitting, and the ultrafine fibers of the high terry fabrics and the low terry fabrics have a denier of 150-600D/200-1000F.

The mop cleaning cloth of the present invention can be repeatedly used after being washed with water and dried and can also be used as a disposable product.

The mop cleaning cloth of the present invention has the following beneficial effects:

1. The dirt removal layer is formed by high and low terries. When a floor is mopped, the high terries are used for collecting and absorbing dirt, and the low terries are used for rubbing the floor to wipe off stains adhering to the floor, so that the situation that the dirt collection capacity is affected by an integrated surface formed by terries with the same height is avoided, and the friction force of a mop to the floor can be reduced;

2. The water-absorption layer is formed by a non-woven fabric made from fibers with different melting points, and after the water-absorption layer is formed, heating is conducted to melt the low-melting point fibers and to bond the high-melting point fibers together, so that the hardness of the water-absorption layer is improved, and accordingly, the overall hardness of the mop cleaning cloth is improved;

3. The method for manufacturing the mop cleaning cloth of the present invention is simple, and the mop cleaning cloth is easy to manufacture and has the advantages of being small in resistance, high in water absorptivity and dirt collection and removal capacity, and the like.

### BRIEF DESCRIPTION OF THE SEVERAL VIEWS OF THE DRAWINGS

FIG. 1 is a structural view of a mop cleaning cloth of the present invention.

### DETAILED DESCRIPTION OF EMBODIMENTS OF THE INVENTION

A further description of the present invention is given as follows in combination with the drawings and specific embodiments, but the protection scope of the present invention is by no means limited to the following description.

### Embodiment 1

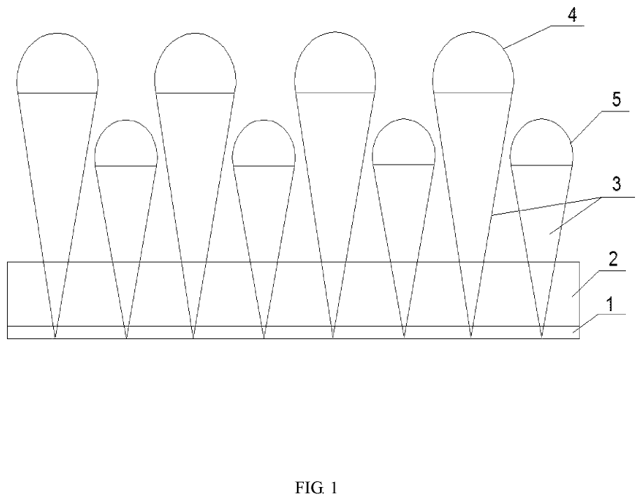

Referring to FIG. 1, a mop cleaning cloth comprises, sequentially from bottom to top, a base cloth layer 1, a water-absorption layer 2 and a dirt removal layer 3. The dirt removal layer is formed by high terry fabrics 4 and low terry fabrics 5, wherein the ratio of a terry height of the high terry fabrics 4 to a terry height of the low terry fabrics 5 is 2:1. The high terry fabrics 4 have a terry height of 10 mm. The low terry fabrics 5 have a terry height of 5 mm. When the mop cleaning cloth is used for mopping a floor, the high terry fabrics 4 are used for collecting and absorbing dirt, while the low terry fabrics 5 are used for rubbing the floor to wipe off stains adhering to the floor, so that the situation that the dirt collection capacity is affected by an integrated surface formed by terries with the same height is prevented, and the friction force of a mop to the floor is reduced.

The water-absorption layer is formed by a water-absorption fabric made from water-absorption fibers. The water-absorption fabric is a non-woven fabric which is made from high-melting point fibers and low-melting point fibers blended with the high-melting point fibers through a needle punching method. After the blended fibers are reinforced into the fabric through carding, lapping and needle punching, the water-absorption layer is heated to melt the low-melting point fibers (the high-melting point fibers are not molten) and to bond the high-melting point fibers together, and the overall hardness of the water-absorption layer is improved after cooling and shaping. In the water-absorption layer, the high-melting point fibers has a mass fraction of 80%, and the low-melting point fibers has a mass fraction of 20%; and the high-melting point fibers are polyester fibers, and the low-melting point fibers are PP/PET composite fibers.

The base cloth layer is formed by a terry fabric. The terry fabric of the base cloth layer can be a non-woven fabric with terries and can be made from polyester, polypropylene, cotton and the like. The water-absorption layer 2 and the dirt removal layer 3 are fixed on the base cloth layer 1 through stitch-knitting by a warp knitting machine.

When the mop cleaning cloth is used, the base cloth layer of the mop cleaning cloth is fixed on a mop head through a hook-terry structure.

A method for manufacturing the mop cleaning cloth comprises the following steps:

(1) the base cloth layer is manufactured: the terry fabric of the base cloth layer is made;

(2) the water-absorption layer is manufactured: the water-absorption fabric is made from water-absorption fibers;

(3) the water-absorption fabric is fixed on the base cloth layer by stitching yarn through stitch-knitting, and meanwhile, ultrafine fibers are stitched and knitted on the base cloth layer, so that the dirt removal layer formed by the high terry fabrics and the low terry fabrics is obtained; and

(4) the water-absorption layer is heated to melt the low-melting point fibers in the water-absorption layer and to bond the high-melting point fibers together, and the mop cleaning cloth is obtained after cooling and shaping.

In step (3), a warp knitting machine is used for stitch-knitting and is provided with two rows of guide bars, wherein the first row of guide bars are used for stitching and knitting the ultrafine fibers on the base cloth layer to obtain the dirt removal layer formed by the high terry fabrics and the low terry fabrics. The second row of guide bars are used for fixing the non-woven fabric of the water-absorption layer on the base cloth layer by stitching yarn; and the non-woven fabric is fixed on the base cloth layer by 80D stitching yarn through stitch-knitting, and the ultrafine fibers of the high terry fabrics and the low terry fabrics have a denier of 150D/288F.

### Embodiment 2

Referring to FIG. 1, a mop cleaning cloth comprises, sequentially from bottom to top, a base cloth layer 1, a water-absorption layer 2 and a dirt removal layer 3. The dirt removal layer is formed by high terry fabrics 4 and low terry fabrics 5, wherein the ratio of a terry height of the high terry fabrics 4 to a terry height of the low terry fabrics 5 is 5:1. The high terry fabrics 4 have a terry height of 15 mm. The low terry fabrics 5 have a terry height of 3 mm. When the mop cleaning cloth is used for mopping a floor, the high terry fabrics 4 are used for collecting and absorbing dirt, while the low terry fabrics 5 are used for rubbing the floor to wipe off stains adhering to the floor, so that the situation that the dirt collection capacity is affected by an integrated surface formed by terries with the same height is prevented, and the friction force of a mop to the floor is reduced.

The water-absorption layer is formed by a water-absorption fabric made from water-absorption fibers. The water-absorption fabric is a non-woven fabric which is made from high-melting point fibers and low-melting point fibers blended with the high-melting point fibers through a needle punching method. After the blended fibers are reinforced into the fabric through carding, lapping and needle punching, the water-absorption layer is heated to melt the low-melting point fibers and to bond the high-melting point fibers together, and the overall hardness of the water-absorption layer is improved after cooling and shaping. In the water-absorption layer, the high-melting point fibers has a mass fraction of 75%, and the low-melting point fibers has a mass fraction of 25%; and the high-melting point fibers are polyester fibers, and the low-melting point fibers are polyethylene fibers.

The base cloth layer is formed by a terry fabric. The terry fabric of the base cloth layer can be a non-woven fabric with terries and can be made from polyester, polypropylene, cotton and the like. The water-absorption layer 2 and the dirt removal layer 3 are fixed on the base cloth layer 1 through stitch-knitting by a warp knitting machine.

A method for manufacturing the mop cleaning cloth comprises the following Steps:

(1) the base cloth layer is manufactured: the terry fabric of the base cloth layer is made;

(2) the water-absorption layer is manufactured: the water-absorption fabric is made from water-absorption fibers;

(3) the water-absorption fabric is fixed on the base cloth layer by stitching yarn through stitch-knitting, and meanwhile, ultrafine fibers are stitched and knitted on the base cloth layer, so that the dirt removal layer formed by the high terry fabrics and the low terry fabrics is obtained; and

(4) the water-absorption layer is heated to melt the low-melting point fibers in the water-absorption layer and to bond the high-melting point fibers together, and the mop cleaning cloth is obtained after cooling and shaping.

In step (3), a warp knitting machine is used for stitch-knitting and is provided with two rows of guide bars, wherein the first row of guide bars are used for stitching and knitting the ultrafine fibers on the base cloth layer to obtain the dirt removal layer formed by the high terry fabrics and the low terry fabrics. The second row of guide bars are used for fixing the non-woven fabric of the water-absorption layer on the base cloth layer by stitching yarn; and the non-woven fabric is fixed on the base cloth layer by 100D stitching yarn through stitch-knitting, and the fibers of the high terry fabrics and the low terry fabrics have a denier of 600D/1000F.

### Embodiment 3

Referring to FIG. 1, a mop cleaning cloth comprises, sequentially from bottom to top, a base cloth layer 1, a water-absorption layer 2 and a dirt removal layer 3. The dirt removal layer is formed by high terry fabrics 4 and low terry fabrics 5, wherein the ratio of a terry height of the high terry fabrics 4 to a terry height of the low terry fabrics 5 is 1.5:1. The high terry fabrics 4 have a terry height of 6 mm. The low terry fabrics 5 have a terry height of 4 mm. When the mop cleaning cloth is used for mopping a floor, the high terry fabrics 4 are used for collecting and absorbing dirt, while the low terry fabrics 5 are used for rubbing the floor to wipe off stains adhering to the floor, so that the situation that the dirt collection capacity is affected by an integrated surface formed by terries with the same height is prevented, and the friction force of a mop to the floor is reduced.

The water-absorption layer is formed by a water-absorption fabric made from water-absorption fibers. The water-absorption fabric is a non-woven fabric which is made from high-melting point fibers and low-melting point fibers blended with the high-melting point fibers through a needle punching method. After the blended fibers are reinforced into the fabric through carding, lapping and needle punching, the water-absorption layer is heated to melt the low-melting point fibers and to bond the high-melting point fibers together, and the overall hardness of the water-absorption layer is improved after cooling and shaping. In the water-absorption layer, the high-melting point fibers has a mass fraction of 80%, and the low-melting point fibers has a mass fraction of 20%; and the high-melting point fibers are polyamide fibers, and the low-melting point fibers are polyethylene fibers.

The base cloth layer is formed by a terry fabric. The terry fabric of the base cloth layer can be a non-woven fabric with terries and can be made from polyester, polypropylene, cotton and the like. The water-absorption layer 2 and the dirt removal layer 3 are fixed on the base cloth layer 1 through stitch-knitting by a warp knitting machine.

A method for manufacturing the mop cleaning cloth comprises the following steps:

(1) the base cloth layer is manufactured: the terry fabric of the base cloth layer is made;

(2) the water-absorption layer is manufactured: the water-absorption fabric is made from water-absorption fibers;

(3) the water-absorption fabric is fixed on the base cloth layer by stitching yarn through stitch-knitting, and meanwhile, ultrafine fibers are stitched and knitted on the base cloth layer, so that the dirt removal layer formed by the high terry fabrics and the low terry fabrics is obtained; and

(4) the water-absorption layer is heated to melt the low-melting point fibers in the water-absorption layer and to bond the high-melting point fibers together, and the mop cleaning cloth is obtained after cooling and shaping.

In step (3), a warp knitting machine is used for stitch-knitting and is provided with two rows of guide bars, wherein the first row of guide bars are used for stitching and knitting the ultrafine fibers on the base cloth layer to obtain the dirt removal layer formed by the high terry fabrics and the low terry fabrics. The second row of guide bars are used for fixing the non-woven fabric of the water-absorption layer on the base cloth layer by stitching yarn; and the non-woven fabric is fixed on the base cloth layer by 75D stitching yarn through stitch-knitting, and the fibers of the high terry fabrics and the low terry fabrics have a denier of 300D/500F.

### Embodiment 4

Referring to FIG. 1, a mop cleaning cloth comprises, sequentially from bottom to top, a base cloth layer 1, a water-absorption layer 2 and a dirt removal layer 3. The dirt removal layer is formed by high terry fabrics 4 and low terry fabrics 5, wherein the ratio of a terry height of the high terry fabrics 4 to a terry height of the low terry fabrics 5 is 3:1. The high terry fabrics 4 have a terry height of 9 mm. The low terry fabrics 5 have a terry height of 3 mm. When the mop cleaning cloth is used for mopping a floor, the high terry fabrics 4 are used for collecting and absorbing dirt, while the low terry fabrics 5 are used for rubbing the floor to wipe off stains adhering to the floor, so that the situation that the dirt collection capacity is affected by an integrated surface formed by terries with the same height is prevented, and the friction force of a mop to the floor is reduced.

The water-absorption layer is formed by a water-absorption fabric made from water-absorption fibers. The water-absorption fabric is a non-woven fabric, which is made from hemp fibers and has good water absorptivity as well as good antibacterial performance.

The base cloth layer is formed by a terry fabric. The terry fabric of the base cloth layer can be a non-woven fabric with terries and can be made from polyester, polypropylene, cotton and the like. The water-absorption layer 2 and the dirt removal layer 3 are fixed on the base cloth layer 1 through stitch-knitting by a warp knitting machine.

A method for manufacturing the mop cleaning cloth comprises the following steps:

(1) the base cloth layer is manufactured: the terry fabric of the base cloth layer is made;

(2) the water-absorption layer is manufactured: the water-absorption fabric is made from water-absorption fibers;

(3) the water-absorption fabric is fixed on the base cloth layer by stitching yarn through stitch-knitting, and meanwhile, ultrafine fibers are stitched and knitted on the base cloth layer, so that the dirt removal layer formed by the high terry fabrics and the low terry fabrics is obtained, and accordingly, the mop cleaning cloth is obtained.

In step (3), a warp knitting machine is used for stitch-knitting and is provided with two rows of guide bars, wherein the first row of guide bars are used for stitching and knitting the ultrafine fibers on the base cloth layer to obtain the dirt removal layer formed by the high terry fabrics and the low terry fabrics. The second row of guide bars are used for fixing the non-woven fabric of the water-absorption layer on the base cloth layer by stitching yarn; and the non-woven fabric is fixed on the base cloth layer by 90D stitching yarn through stitch-knitting, and the fibers of the high terry fabrics and the low terry fabrics have a denier of 150D/288F.

The mop cleaning cloth of the present invention can be repeatedly used after being washed with water and dried and can also be used as a disposable product. The manufacturing method is simple, and the mop cleaning cloth is easy to manufacture and has the advantages of being small in resistance, high in water absorptivity and dirt collection and removal capacity, and the like.

### Embodiment 5

Referring to FIG. 1, a mop cleaning cloth comprises, sequentially from bottom to top, a base cloth layer 1, a water-absorption layer 2 and a dirt removal layer 3. The dirt removal layer is formed by high terry fabrics 4 and low terry fabrics 5, wherein the ratio of a terry height of the high terry fabrics 4 to a terry height of the low terry fabrics 5 is 2:1. The high terry fabrics 4 have a terry height of 10 mm. The low terry fabrics 5 have a terry height of 5 mm. When the mop cleaning cloth is used for mopping a floor, the high terry fabrics 4 are used for collecting and absorbing dirt, while the low terry fabrics 5 are used for rubbing the floor to wipe off stains adhering to the floor, so that the situation that the dirt collection capacity is affected by an integrated surface formed by terries with the same height is prevented, and the friction force of a mop to the floor is reduced.

The water-absorption layer is formed by a water-absorption fabric made from water-absorption fibers. The water-absorption fabric is a non-woven fabric. The non-woven fabric is made from hydrophilic polyester fibers through carding, lapping and needle-punching reinforcement.

The base cloth layer is formed by a terry fabric. The terry fabric of the base cloth layer can be a non-woven fabric with terries and can be made from polyester, polypropylene, cotton and the like. The water-absorption layer 2 and the dirt removal layer 3 are fixed on the base cloth layer 1 through stitch-knitting by a warp knitting machine.

A method for manufacturing the mop cleaning cloth comprises the following Steps:

(1) the base cloth layer is manufactured: the terry fabric of the base cloth layer is made;

(2) the water-absorption layer is manufactured: the water-absorption fabric is made from water-absorption fibers;

(3) the water-absorption fabric is fixed on the base cloth layer by stitching yarn through stitch-knitting, and meanwhile, ultrafine fibers are stitched and knitted on the base cloth layer, so that the dirt removal layer formed by the high terry fabrics and the low terry fabrics is obtained; and

(4) the water-absorption layer is heated to melt the low-melting point fibers in the water-absorption layer and to bond the high-melting point fibers together, and the mop cleaning cloth is obtained after cooling and shaping.

In step (3), a warp knitting machine is used for stitch-knitting and is provided with two rows of guide bars, wherein the first row of guide bars are used for stitching and knitting the ultrafine fibers on the base cloth layer to obtain the dirt removal layer formed by the high terry fabrics and the low terry fabrics. The second row of guide bars are used for fixing the non-woven fabric of the water-absorption layer on the base cloth layer by stitching yarn; and the non-woven fabric is fixed on the base cloth layer by 80D stitching yarn through stitch-knitting, and the ultrafine fibers of the high terry fabrics and the low terry fabrics have a denier of 150D/288F.

### Embodiment 6

Referring to FIG. 1, a mop cleaning cloth comprises, sequentially from bottom to top, a base cloth layer 1, a water-absorption layer 2 and a dirt removal layer 3. The dirt removal layer is formed by high terry fabrics 4 and low terry fabrics 5, wherein the ratio of a terry height of the high terry fabrics 4 to a terry height of the low terry fabrics 5 is 5:1. The high terry fabrics 4 have a terry height of 15 mm. The low terry fabrics 5 have a terry height of 3 mm. When the mop cleaning cloth is used for mopping a floor, the high terry fabrics 4 are used for collecting and absorbing dirt, while the low terry fabrics 5 are used for rubbing the floor to wipe off stains adhering to the floor, so that the situation that the dirt collection capacity is affected by an integrated surface formed by terries with the same height is prevented, and the friction force of a mop to the floor is reduced.

The water-absorption layer is formed by a water-absorption fabric made from water-absorption fibers. The water-absorption fabric is a woven fabric made from cotton fibers. Similarly, the water-absorption fabric can also be a woven fabric made from hemp fibers.

The base cloth layer is formed by a terry fabric. The terry fabric of the base cloth layer can be a non-woven fabric with terries and can be made from polyester, polypropylene, cotton and the like. The water-absorption layer 2 and the dirt removal layer 3 are fixed on the base cloth layer 1 through stitch-knitting by a warp knitting machine.

A method for manufacturing the mop cleaning cloth comprises the following Steps:

(1) the base cloth layer is manufactured: the terry fabric of the base cloth layer is made;

(2) the water-absorption layer is manufactured: the water-absorption fabric is made from water-absorption fibers;

(3) the water-absorption fabric is fixed on the base cloth layer by stitching yarn through stitch-knitting, and meanwhile, ultrafine fibers are stitched and knitted on the base cloth layer, so that the dirt removal layer formed by the high terry fabrics and the low terry fabrics is obtained; and

(4) the water-absorption layer is heated to melt the low-melting point fibers in the water-absorption layer and to bond the high-melting point fibers together, and the mop cleaning cloth is obtained after cooling and shaping.

In step (3), a warp knitting machine is used for stitch-knitting and is provided with two rows of guide bars, wherein the first row of guide bars are used for stitching and knitting the ultrafine fibers on the base cloth layer to obtain the dirt removal layer formed by the high terry fabrics and the low terry fabrics; the second row of guide bars are used for fixing the non-woven fabric of the water-absorption layer on the base cloth layer by stitching yarn; and the non-woven fabric is fixed on the base cloth layer by 80D stitching yarn through stitch-knitting, and the fibers of the high terry fabrics and the low terry fabrics have a denier of 300D/500F.

1. A method for manufacturing a mop cleaning cloth, wherein the mop cleaning cloth comprising, sequentially from bottom to top, a base cloth layer, a water-absorption layer and a dirt removal layer, wherein the dirt removal layer is formed by high terry fabrics and low terry fabrics, the ratio of a terry height of the high terry fabrics to a terry height of the low terry fabrics is 1.1-5:1, the high terry fabrics have a terry height of 2-20 mm, and the low terry fabrics have a terry height of 1-10 mm; and the water-absorption layer is formed by a water-absorption fabric made from water-absorption fibers, and the base cloth layer is formed by a terry fabric; characterized in that the method comprises the following steps:
(1) manufacturing the base cloth layer: making the terry fabric of the base cloth layer;
(2) manufacturing the water-absorption layer: making the water-absorption fabric from water-absorption fibers; and
(3) fixing the water-absorption fabric on the base cloth layer by stitching yarn through stitch-knitting, and meanwhile, stitching and knitting ultrafine fibers on the base cloth layer, so that the dirt removal layer formed by the high terry fabrics and the low terry fabrics is obtained, and accordingly, the mop cleaning cloth is obtained.

2. The method for manufacturing the mop cleaning cloth according to claim 1, wherein in step (2), the water-absorption fabric of the water-absorption layer is a non-woven fabric made from high-melting point fibers and low-melting point fibers blended with the high-melting point fibers through a needle punching method, and the blended fibers are reinforced into the fabric through carding, lapping and needle punching; and the method for manufacturing the mop cleaning cloth further comprises step (4): heating the water-absorption layer to melt the low-melting point fibers in the water-absorption layer and to bond the high-melting point fiber together, and obtaining the mop cleaning cloth after cooling and shaping.

3. The method for manufacturing the mop cleaning cloth according to claim 1, wherein in step (3), a warp knitting machine is used for stitch-knitting and is provided with two rows of guide bars, wherein the first row of said guide bars are used for stitching and knitting the ultrafine fibers on the base cloth layer to obtain the dirt removal layer formed by the high terry fabrics and the low terry fabrics; the second row of said guide bars are used for stitching and knitting the non-woven fabric of the water-absorption layer on the base cloth layer by stitching yarn; and the non-woven fabric is fixed on the base cloth layer by 75-100D stitching yarn through stitch-knitting, and the ultrafine fibers of the high terry fabrics and the low terry fabrics have a denier of 150-600D/200-1000F.

4. The method for manufacturing the mop cleaning cloth according to claim 1, wherein the water-absorption fabric is a non-woven fabric, which is made from any one or two water-absorption fibers selected from cotton fibers, hemp fibers, hydrophilic polyester fibers and polyamide fibers.

5. The method for manufacturing the mop cleaning cloth according to claim 4, wherein the non-woven fabric of the water-absorption layer is made from high-melting point fibers and low-melting point fibers blended with the high-melting point fibers through a needle punching method, and after the blended fibers are reinforced into the fabric through carding, lapping and needle punching, the water-absorption layer is heated to melt the low-melting point fibers and to bond the high-melting point fibers together, and the overall hardness of the water-absorption layer is improved after cooling and shaping.

6. The method for manufacturing the mop cleaning cloth according to claim 5, wherein the high-melting point fibers have a melting point over 200° C., the low-melting point fibers have a melting point lower than 200° C.; and in the water-absorption layer, the high-melting point fibers have a mass fraction of 70-90%, and the low-melting point fibers have a mass fraction of 10-30%.

7. The method for manufacturing the mop cleaning cloth according to claim 5, wherein the high-melting point fibers are polyester fibers or polyamide fibers, and the low-melting point fibers are PP/PET composite fibers, polyethylene fibers or polypropylene fibers.

8. The method for manufacturing the mop cleaning cloth according to claim 1, wherein the water-absorption layer and the dirt removal layer are fixed on the base cloth layer through stitch-knitting by a warp knitting machine.

9. The method for manufacturing the mop cleaning cloth according to claim 1, wherein the high terry fabrics and the low terry fabrics are made from ultrafine fibers with a denier of 150-600D/200-1000F, the high terry fabrics have a terry height of 3-10 mm, and the low terry fabrics have a terry height of 1-5 mm.
